(19) United States
(12) Patent Application Publication
(10) Pub. No.: US 2026/0243156 A1
(43) Pub. Date: Aug. 20, 2026

(54) Apparatus and Method for Separating Solids from Produced Well Fluids

(71) Applicant: Batfer Investment S.A., Montevideo (UY)

(72) Inventors: Jake Feil, Berthold, ND (US); Jason Pitcher, Magnolia, TX (US)

(21) Appl. No.: 19/540,911

(22) Filed: Feb. 16, 2026

Related U.S. Application Data
(60) Provisional application No. 63/759,972, filed on Feb. 18, 2025.
(60) Provisional application No. 63/828,705, filed on Jun. 23, 2025.

(51) Int. Cl. E21B 43/267; B01D 45/12; E21B 43/12; E21B 43/34; E21B 43/38

(52) U.S. Cl. CPC E21B 43/35; B01D 45/12; E21B 43/12; E21B 43/38; E21B 43/267

(57) ABSTRACT

The present invention includes a first separation vessel disposed above a second vessel. The first separation vessel has a plurality of inlets, a removable cyclone module, an upper outlet, and a lower outlet coupled to the second vessel. The removable cyclone module includes at least one cyclonic separator configured to separate at least a portion of particulate matter from the well production and to discharge such matter from the lower outlet, and to separate at least a portion of the liquid and gases in the well production and discharge such fluid from the upper outlet. The second vessel may include an inner surface with an inlet disposed on a top portion of the vessel, and an outlet disposed on a bottom portion of the vessel. The produced well fluids from a wellhead are directed to the plurality of inlets in the first separation vessel selectively via a manifold. The manifold has multiple valves, either manually operated or actuated via hydraulic, pneumatic, or electric actuators.

### CROSS REFERENCE TO RELATED APPLICATION

This application claims priority to U.S. Application No. 63/828,705 filed on Jun. 23, 2025, and U.S. Application No. 63/759,972 filed on Feb. 18, 2025, the disclosures of which are both incorporated herein by reference for all purposes.

### FIELD OF THE INVENTION

The present invention relates to systems for separating a multi-component flow into one or more of its components. In particular, the present invention relates to separating sand and other particulates from subterranean well production, and specifically, to controlling the speed of the flow.

### BACKGROUND OF THE INVENTION

Production from a subterranean well is typically a combination of solids, water (typically brine), and liquid and gaseous hydrocarbons. The solids or particulates typically are parts of the formation from which the hydrocarbons are being produced, particulates introduced into the well by hydraulic fracturing, and/or produced by a phase change of hydrocarbons (asphalt or wax formation). Particulate flow from the well may cause problems through abrasion or plugging of production equipment. Stimulated wells have been known to produce sand for a month or more after production begins.

The industry has developed equipment intended to separate well production into one or more of its constituent parts, including sand knock out equipment, desanders, and separating tanks. For example, U.S. Pat. No. 7,147,788 teaches the use of a combination of cyclone separators and gravity separators to remove the sand from a production well stream, thereby enhancing the quality of the recovered oil, gas, and water output streams and reducing erosion caused by entrained sand. U.S. Pat. No. 8,252,179 teaches the use of a liquid cyclone to remove impurities from water. U.S. Pat. No. 9,821,257 teaches a dynamic particle separator which uses cyclone separation to remove sand from a petroleum gas stream. All patents listed above are incorporated herein by reference for all purposes.

The present invention is an improved sand separation system.

### SUMMARY OF THE INVENTION

In one aspect, the present invention may include a first separation vessel disposed above a second vessel. The first separation vessel may have a plurality of inlets, a removable cyclone module, an upper outlet, and a lower outlet coupled to the second vessel. The removable cyclone module may include at least one cyclonic separator configured to separate at least a portion of particulate matter from the well production and to discharge such matter from the lower outlet, and to separate at least a portion of the liquid and gases in the well production and discharge such fluid from the upper outlet. The second vessel may include an inner surface with an inlet disposed on a top portion of the vessel, and an outlet disposed on a bottom portion of the vessel. The produced well fluids from a wellhead are directed to a plurality of inlets in the first separation vessel selectively via a manifold. The manifold may have multiple valves, either manually operated or actuated via hydraulic, pneumatic, or electric actuators.

In another aspect, the present invention may include a method of separating production fluid from a subterranean well into one or more components by introducing the production fluid into a first vessel including a cyclone module having one or more cyclonic separators. A second cyclone module may be installed, with both cyclone modules disposed to discharge via a lower connection to a second separator vessel. The outlets of the plurality of cyclone modules may be joined via a manifold to exhaust the production stream for further processing.

While the present disclosure may be susceptible to various modifications and alternative forms, specific embodiments have been shown by way of example in the drawings and have been described in detail herein. However, it should be understood that the present disclosure is not intended to be limited to the particular forms disclosed. Rather, the present disclosure is to cover all modifications, equivalents, and alternatives falling within the spirit and scope of the disclosure as defined by the claims.

### BRIEF DESCRIPTION OF THE DRAWINGS

FIG. 1 is a perspective view of one embodiment of the multi-port separator of the present invention.

FIG. 2 is a top plan view of the separator shown in FIG. 1.

FIG. 3 is a cross-section taken along the line A-A of FIG. 2.

FIG. 4 is a perspective view of one embodiment of the sand separation system of the present invention.

FIG. 5 is a top plan view of the system shown in FIG. 4.

FIG. 6 is a cross-section taken along the lines A-A in FIG. 5.

FIG. 7 is a cross-section taken along the lines B-B in FIG. 6.

FIG. 8 is a schematic showing the components of the sand separation system of the present invention.

### DETAILED DESCRIPTION OF PREFERRED EMBODIMENTS

Embodiments of the invention are described more fully hereafter with reference to the accompanying drawings. Elements that are identified using the same or similar reference characters refer to the same or similar elements which perform the same functions across various embodiments. The various embodiments of the invention may, however, be embodied in many different forms and should not be construed as limited to the embodiments set forth herein. Rather, these embodiments are provided so that this disclosure will be thorough and complete, and will fully convey the scope of the invention to those skilled in the art.

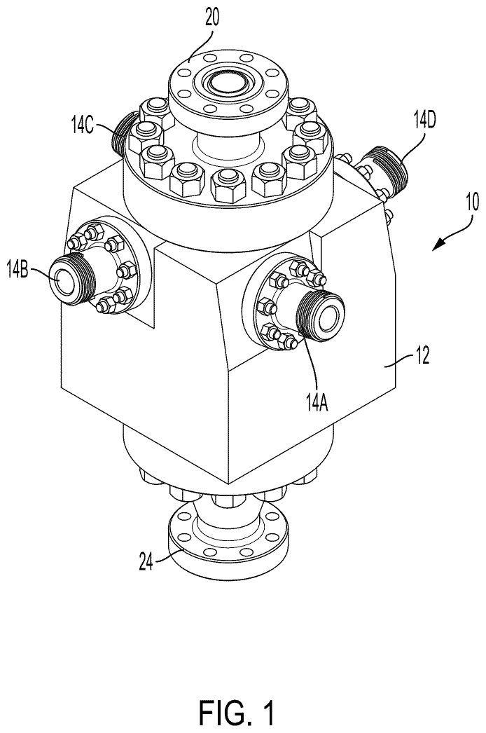

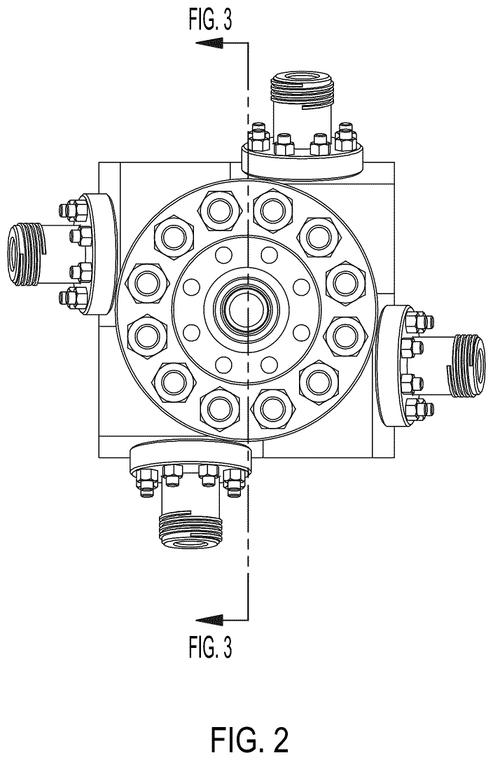

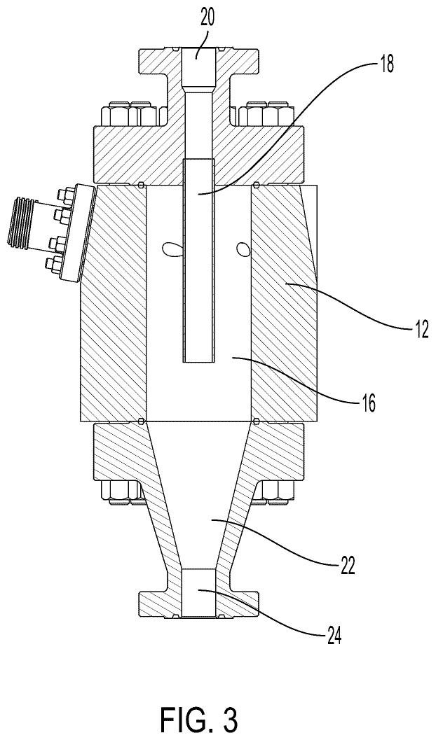

Turning to FIGS. 1-3 there is shown one embodiment of the first separation vessel of the present invention. First separation vessel 10 has a body 12 and a plurality of inlets 14A, 14B, 14C, and 14D. It will be appreciated that the exact number of inlets may vary. Within body 12 is a chamber 16. Extending partway through the center of chamber 16 is a central conduit 18 which connects to upper outlet 20. Below chamber 16 is a funnel 20 which connects to lower outlet 24. Production fluid from a wellhead enters first separation vessel 10 through one or more inlets 14A-14D. In a preferred embodiment, first separation vessel 10 is a cyclonic separator. The production fluid is thus driven around chamber 16 in a cyclonic motion. Heavier particulates, sand, and the like are driven toward the wall of chamber 16 and ultimately down into funnel 22 and lower outlet 24. Lighter components of the production fluid flow up through central conduit 18 and out upper outlet 20.

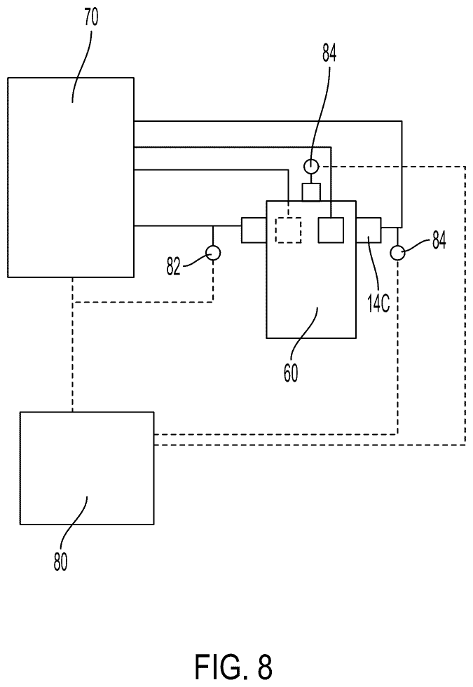

To determine which of inlets 14A-14D are used, production fluid from a wellhead is first sent through a manifold 60 (see FIG. 8). The manifold 60 has conduits connected to each inlet 14A-14D. Manifold 60 has multiple valves, either manually operated or actuated via hydraulic, pneumatic, or electric actuators which open and close off access to inlets 14A-14D. Manifold 60 is operatively connected to a controller 70 which controls the opening and closing of the valves in the manifold. When the production fluid from the wellhead is at an appropriate velocity, all four valves 14A-14D are open. Over time the flow from the wellhead lessens. When this happens, the controller will close one or more valves. By closing the valves, the flow of fluid becomes concentrated to a few number of inlets. The concentration of the fluid increases the velocity of the fluid entering the cyclone and ensures a sufficient velocity is maintained for the first separation vessel. Fluid flowing too slowly will not form the cyclone needed to separate the particles but rather will simply exhaust through the outlet 18. A certain flow velocity is required to achieve the desired separation of sand/heavy materials. Additionally, the sizes of the inlets may vary depending on the situation. If the inlets are different sizes, the fluid flow can be changed by opening and closing valves of different sizes to obtain the needed velocity.

In one embodiment one or more flow meters 82 are attached between the manifold and one of the respective inlets 14 on first separation vessel. The flow meter(s) 82 is operatively connected to controller 70. If the flow measured by the flow meter 82 drops below a certain amount, controller 70 will signal manifold 60 to close one of the valves, thus stopping fluid flow to one of the inlets 14A-14D. If the velocity continues to remain below a desired amount, the controller 70 will signal for the closure of another valve. If only one of the inlets 14A-14D has a flowmeter associated with it, that should be the inlet to remain open so that the flow is continually monitored. If every inlet 14A-14D has a flow meter 82 associated with it, or the flowmeter is installed upstream of the manifold 60, the specific inlets being closed off can be varied, thus spreading out the wear and tear among the multiple inlets. It will also be appreciated that a flow meter 82 can be affixed downstream of upper outlet 20 to measure the flow of the fluid after the heavier particles have been removed.

In another embodiment, pressure sensors 84 (see FIG. 8) are positioned at each inlet and the upper outlet of first separation vessel. The pressure sensors are also connected to the controller. The controller can measure the differential pressure from the inlet(s) and upper outlet. Monitoring the pressure differential can identify potential problems in any of the lines and can also be used to determine how many/which inlets should be open in the first separation vessel.

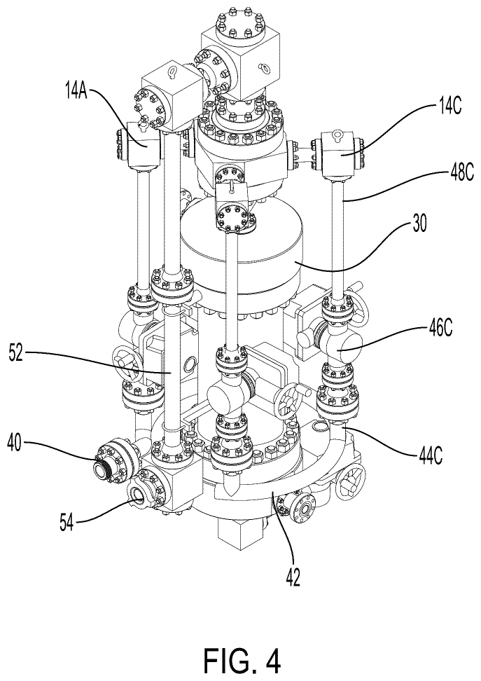

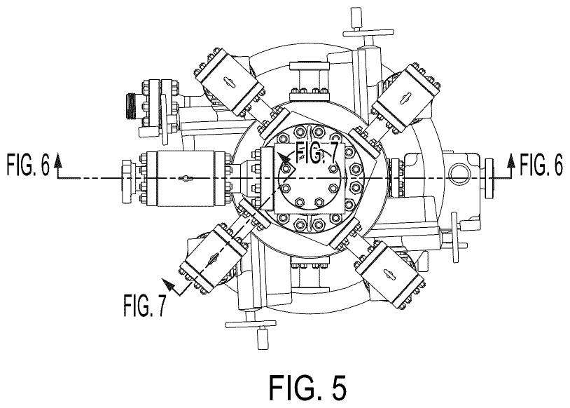

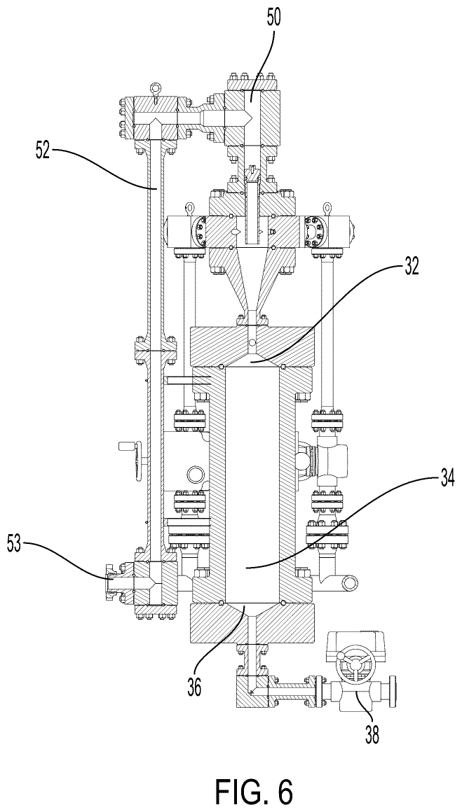

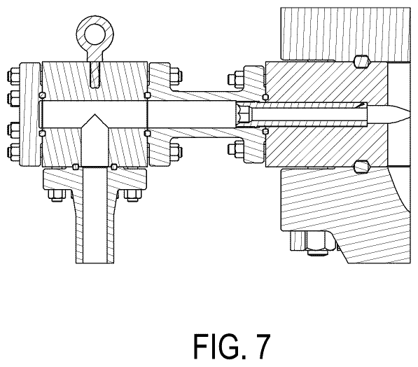

Turning to FIGS. 4-7 there is shown one embodiment of a sand separation system 100 using the first separation vessel of the present invention. It will be appreciated that the exact configuration of the components may vary from those shown in FIGS. 4-7. If desired, more than one separation vessel may be used. In the system of FIGS. 4-7, first separation vessel 10 is mounted atop second vessel 30. Second vessel 30 has an inlet 32 for receiving the heavy materials from first separation vessel 10. The sand/heavy material is held in collection area 34 until a certain level is reached. When it is time to empty collection area 34, dump valve 38 is opened and the sand/heavy material flows through outlet 36 and on to a storage vessel, sand recycling system, or the like.

As depicted in FIGS. 4-7, production fluid enters the system 100 through inlet 40 and travels along halo 42. Conduits 44A, 44B, 44C, and 44D connect halo 42 to respective valves 46A, 46B, 46C, and 46D. These valves 46A-46D are the valves actuated by the controller 70. When open, fluid passes through the valves through respective lines 48A-48D into the respective first separation vessel inlets 14A-14D. When one or more of valves 46A-46D is closed, the fluid only passes through those valves which remain open. The velocity of the fluid into first separation vessel 10 can thus be controlled.

Production fluid leaving first separation vessel 10 through upper outlet 20 passes through production line inlet 50, production line 52, and through production line outlet 54 for further processing.

The present invention provides advantages over prior art sand separation systems. Other systems control the speed of the fluid flow with a throttling valve at the inlet of the first separation vessel. By widening and narrowing the path the production fluid flows through, the speed of the production fluid can be changed. Narrowing the flow path increases the flow speed. In Applicant's invention, rather than throttling a single inlet, there are multiple inlets used. This allows for a longer life of the system. When the speed of the production fluid must be increased, one or more of the inlets are closed off. The closed inlet thus endures less wear and tear. Additionally, with the controller and manifold, the specific inlets being closed off can change. Thus the wear and tear can be spread out over multiple inlets and not concentrated on the same inlet every time.

Although specific embodiments of the invention have been described herein in some detail, this has been done solely for the purposes of explaining the various aspects of the invention and is not intended to limit the scope of the invention as defined in the claims which follow. Those skilled in the art will understand that the embodiment shown and described is exemplary, and various other substitutions, alterations and modifications, including but not limited to those design alternatives specifically discussed herein, may be made in the practice of the invention without departing from its scope.

1. A production fluid separation system, comprising:
a manifold connected to a plurality of inlets in a first separation vessel;
said first separation vessel being a cyclonic separator having an upper outlet and a lower outlet, and said first separation vessel being configured to receive production fluid and separate particulate matter and at least a portion of liquid and gas from said production fluid, and discharge said liquid and gas from said upper outlet, and discharge at least a portion of particulate matter through said lower outlet.

2. The system of claim 1, further comprising:
a second vessel mounted below said first separation vessel for receiving said particulate matter from said lower outlet of said first separation vessel.

3. The system of claim 1, further comprising:
a plurality of valves to selectively direct the production fluid to one or more of said plurality of inlets.

4. The system of claim 3 wherein said plurality of valves are hydraulically, pneumatically, or electrically actuated.

5. The system of claim 1, wherein each of the plurality of inlets are the same size.

6. The system of claim 1, wherein at least one of the plurality of inlets is a different size from the others.

7. The system of claim 3, wherein a controller is operable to control the valves.

8. The system of claim 7, further comprising at least one flow meter placed in line with at least one of the plurality of inlets to measure flow rate of the production fluids entering the first separation vessel.

9. The system of claim 8, wherein said controller is connected to said flowmeter and uses the readings from said flowmeter to determine the required number of valves to be opened to maintain a flowrate above a desired amount.

10. The system of claim 7, further comprising at least one pressure sensor placed in line with at least one of the plurality of inlets, and one pressure sensor placed at the upper outlet of the first separation vessel, the pressure sensors used to determine the differential pressure of the vessel.
